(19) United States
(12) Patent Application Publication
(10) Pub. No.: US 2014/0041026 A1
(43) Pub. Date: Feb. 6, 2014

(54) Hybrid Virtual Machine

(71) Applicant: Sifteo, Inc., San Francisco, CA (US)

(72) Inventor: Micah Elizabeth Scott, San Francisco, CA (US)

(21) Appl. No.: 13/957,010

(22) Filed: Aug. 1, 2013

Related U.S. Application Data
(60) Provisional application No. 61/678,551, filed on Aug. 1, 2012.

(51) Int. Cl. G06F 21/53

(52) U.S. Cl. CPC G06F 21/53
USPC 726/22

(57) ABSTRACT

A method and system are disclosed for a hybrid virtual machine that allows untrusted software programs to be run securely and with high performance on computers having processors that lack hardware-assisted memory management. Contemporary computer platforms built to enable application developers to deploy software (“apps”) typically employ (a) hardware assisted memory-management and an operating system that “sandboxes” applications' access to hardware peripherals or (b) an interpreted code execution environment that acts as an insulating layer between running application code and the underlying computer hardware, with the environment configured to prevent inappropriate actions. Both contemporary approaches require a processor with a certain base level of performance and/or built-in features, which increases hardware costs. The present invention satisfies the goals of more expensive platforms but is operable on hardware with lesser performance capabilities and/or fewer features.

### RELATED APPLICATION

The present application relates to and claims the benefit of priority to U.S. Provisional Patent Application No. 61/678,551 filed Aug. 1, 2012, which is hereby incorporated by reference in its entirety for all purposes as if fully set forth herein.

### BACKGROUND OF THE INVENTION

1. Field of the Invention

Embodiments of the present invention relate, in general, to virtual computing and more particularly to combining language interpretation and a software implementation of memory management.

2. Relevant Background.

A virtual machine is an isolated guest operating system installation within a normal host operating system. Modern virtual machines can be implemented with either software emulation or hardware virtualization, and in most cases are implemented together. In essence a virtual machine is a software implementation of a machine (i.e. a computer) that executes programs like a physical machine. The virtual machine defines an independent virtual machine instruction set that maps on to the machine instructions of the computer. An essential characteristic of a virtual machine is that the software running inside is limited to the resources and abstractions provided by the virtual machine. In other words, it cannot break out of its virtual environment. One well known example of a virtual machine is the Java programming language. The Java programming language was originally designed for use in the consumer electronics industry so that different microprocessors could be programed using the same language. This platform-independent property of the Java language was found to be ideal for programs distributed on the Internet where different platforms are connected together in a network. Applications are written in high level Java source code, compiled into Java bytecode by a Java compiler and the bytecode is interpreted by the Java Virtual Machine.

Hardware platforms that allow developers to build and distribute their own applications are powerful because they can extend the capabilities of these platforms beyond the ideas and available time of the platform-makers. However, platforms that support the deployment of large numbers of 3rd party applications must allow “untrusted” applications to run safely—that is, they must ensure that applications that are not created by the platform-maker (and that may potentially contain malicious or buggy code) cannot crash or damage the underlying system or access unauthorized data. Contemporary platforms typically satisfy these requirements through either (a) hardware-assisted memory-management and an operating system that “sandboxes” applications' access to hardware peripherals or (b) an interpreted code execution environment that provides an insulating layer between the running application code and the underlying computer hardware, with the environment configured to prevent inappropriate actions.

In computers, a sandbox is a security mechanism for separating running programs from each other or from the underlying system. A sandbox can be used to execute untested code, or untrusted programs from unverified third-parties, suppliers, untrusted users and untrusted websites. The sandbox typically provides a tightly controlled set of resources for guest programs to use, such as a certain amount of “scratch space” on disk and in memory. Network access, the ability to inspect the host system or read/write hardware devices are usually disallowed or heavily restricted. In this sense, sandboxes are a specific example of virtualization. Virtualization is the creation of a virtual (rather than actual) version of something, such as a hardware platform, operating system (OS), storage device, or network resources.

A virtual machine, operating with hardware-assisted memory management, is an example of a sandbox. Virtual machines emulate a complete host computer on which a conventional operating system may boot and run as if on actual hardware. The guest operating system runs sandboxed in the sense that it does not operate natively on the host and can only access host resources through the emulator.

While a physical computer in the classical sense is clearly a complete and actual machine, both subjectively (from the user's point of view) and objectively (from the hardware system administrator's point of view), a virtual machine is subjectively a complete machine (or very close), but objectively merely a set of files and running programs on an actual, physical machine (which the user need not necessarily be aware).

Using a virtual machine is most advantageous in situations either (a) where software must be sandboxed but requires the resources of a “full” host computer, for instance to run a web server and associated hosting tools to run software on a Windows PC that is compiled for the Mac architecture. Full virtual machines tend to be a “heavy” solution to the software sandboxing problem, since the hosted operating system itself will require processor cycles and memory for its own operations in addition to the resources consumed by the running software application.

An interpreter, by comparison, normally means a computer program that executes, i.e. performs, instructions written in a programming language. An interpreter may be a program that either executes the source code directly, translates source code into some efficient intermediate representation (code) and immediately executes the representation, or explicitly executes stored precompiled code made by a compiler that is part of the interpreter system. Conventional interpreters decode and execute instructions of an interpreted program one instruction at a time during execution. Compilers, on the other hand, convert source code into native machine instructions prior to execution so that conversion is not performed during execution. Because conventional interpreters decode and convert each instruction before it is executed repeatedly each time the instruction is encountered, execution of interpreted programs is typically slower than compiled programs because the native machine instructions of compiled programs can be executed on the native machine or computer system without the conversion step.

The main disadvantage of interpreters is that when a program is interpreted, it typically runs more slowly than if it had been compiled. It generally takes longer to run a program under an interpreter than to run the compiled code but it can take less time to interpret it than the total time required to compile and run it. As a solution to the problem of software sandboxing, an interpreter is a “lighter” approach compared to the use of a full virtual machine, since it does not require a second full operating system to be present to run the interpreted application, instead consuming only the system resources to run itself as overhead.

Modern high-end computer systems (e.g. smartphones, tablets, personal computers) typically run programs natively using hardware-supported memory protection. This means that applications are allowed to run directly on the hardware of the system which allows them to run fast, but the system can “catch” or “trap” illegal memory accesses, preventing programs from reading or writing memory or hardware devices allocated to other programs or to the operating system itself.

Microcontroller-based computers power many of the low-cost interactive products that we use in modern life. For instance computer mice, keyboards, dedicated digital cameras, activity trackers, wireless headsets and many electronic toys are typically implemented using microcontrollers. A microcontroller is described here as distinct from the CPU of systems with higher complexity and cost (e.g. smartphones, tablets, personal computers) in that microcontrollers are typically designed to be more self-sufficient, having a wider range of input and signal-generation output peripherals and onboard nonvolatile storage for firmware code. Compared to CPU-based systems, microcontroller-based systems typically have lower clock speed capabilities and many lack the built-in memory management and numerical processing peripherals that are typical in CPU-based systems. These microcontroller-based systems are programmed with a single firmware image that defines their interactive behavior. The firmware is sometimes updated over time with bugfixes and feature enhancements, but is typically written by the maker of the device and is specialized to support only a single type of system behavior. Furthermore, since firmware instructions run directly on the processor of the microcontroller, a high degree of confidence in the program's correctness is required since buggy or malicious code can crash or even physically harm the system. Due to their strict requirements for program correctness, microcontroller-based systems are typically not appropriate platforms for 3rd party developers where applications are written outside the control of the maker of the system. Hobbyist microcontroller platforms like the Arduino are an exception, having been created expressly to run code written by end-users, but since these hobbyist platforms are built for tinkering they disclaim any guarantees about system security and in fact they can be crashed and damaged quite easily, either unintentionally or maliciously.

Currently, systems able to securely run 3rd party applications utilize more complex and expensive CPU-based architectures that provide sufficient RAM, hardware architectures like memory protection, and/or higher clock speed capabilities. These more expensive systems are able to run full operating systems and can sandbox running applications through combinations of virtualization, interpretation, and hardware-supported memory management. The hardware for these systems able to run 3rd party applications is significantly more expensive than the hardware for single-firmware microcontroller-based systems. However, a way to run applications securely on microcontroller-based systems opens up new markets for lower-cost devices whose behavior can be defined by a community of 3rd party software developers, rather than solely by the makers of devices. Needed, therefore is an execution environment that makes the deployment of 3rd party applications practical and secure on limited capability and lower cost systems.

Additional advantages and novel features of this invention shall be set forth in part in the description that follows, and in part will become apparent to those skilled in the art upon examination of the following specification or may be learned by the practice of the invention. The advantages of the invention may be realized and attained by means of the instrumentalities, combinations, compositions, and methods particularly pointed out in the appended claims.

### SUMMARY OF THE INVENTION

Method and system allowing a compiled program to run in a secure way wherein at run time instructions are either directly run if they were determined to be “safe” at compile time, or are handed off to system calls that check their safety before execution. Program code is compiled and apportioned into pages comprised of a region of program instructions and a region of data. “Safe” instructions include arithmetic operations, local loop and branch operations within a code block, operations accessing general purpose registers, operations accessing memory relative to a stack pointer, and operations accessing memory relative to a trusted base pointer. System calls are used to implement “unsafe” instructions including operations writing to a trusted base pointer register, operations for allocating or freeing stack space, operations for accessing a different code block and function calls and return operations. Compile-time optimizations apportion the program into pages of code that minimize the expected frequency of program accesses of code outside the page at run time. Memory management hardware is replaced with software in the form of supervisor calls to validate memory accesses that cannot be determined to be safe at compile-time. Furthermore, the validity of all instructions in the code region of each page is verified by an algorithm at run time. Finally, no type of branch is allowed to enter an address that is not 32-bit aligned.

The features and advantages described in this disclosure and in the following detailed description are not all-inclusive. Many additional features and advantages will be apparent to one of ordinary skill in the relevant art in view of the drawings, specification, and claims hereof. Moreover, it should be noted that the language used in the specification has been principally selected for readability and instructional purposes and may not have been selected to delineate or circumscribe the inventive subject matter; reference to the claims is necessary to determine such inventive subject matter.

### BRIEF DESCRIPTION OF THE DRAWINGS

The aforementioned and other features and objects of the present invention and the manner of attaining them will become more apparent, and the invention itself will be best understood, by reference to the following description of one or more embodiments taken in conjunction with the accompanying drawings, wherein:

FIG. 1 illustrates a compile process according to one embodiment of the present invention whereby source code is converted to pages of machine code that can run in the hybrid virtual machine;

FIG. 2 illustrates virtual memory code page caching whereby pages of compiled code are, according to one embodiment of the present invention, cached into RAM as-needed by an application running in the hybrid virtual machine;

FIG. 3 illustrates typical code execution in the hybrid virtual machine according to one embodiment of the present invention;

FIG. 4 illustrates an exemplary page validation algorithm of the hybrid virtual machine that, according to one embodiment of the present invention, validates code pages to ensure they are safe to run;

FIG. 5 illustrates an exemplary set of valid VM instructions for the hybrid virtual machine of the present invention;

FIG. 6 illustrates an exemplary virtual memory map of the hybrid virtual machine of the present invention;

FIG. 7 illustrates a sample physical memory map for a hardware system that the hybrid virtual machine may run on according to one embodiment of the present invention;

FIG. 8 illustrates example virtual to physical memory address translations in the hybrid virtual machine according to one embodiment of the present invention;

FIG. 9 illustrates exemplary 32-bit instruction encodings allowed by the hybrid virtual machine of the present invention;

FIG. 10 illustrates exemplary 16-bit instruction endings allowed, according to one embodiment of the present invention, by the hybrid virtual machine;

FIG. 11 illustrates exemplary SVC encodings of the hybrid virtual machine of the present invention;

FIG. 12 illustrates exemplary 32-bit literal encodings of the hybrid virtual machine of the present invention;

FIG. 13 illustrates defined addrop numbers in the hybrid virtual machine of the present invention;

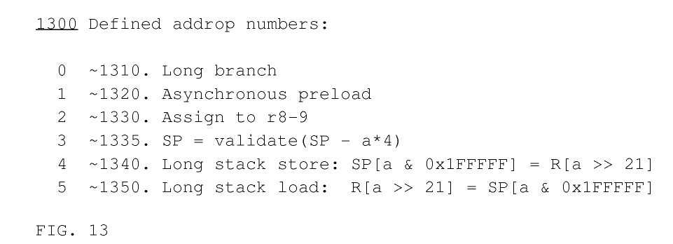

FIG. 14 illustrates one example of a stack layout in the hybrid virtual machine of the present invention;

FIG. 15 illustrates the overall hybrid virtual machine system according to one embodiment of the present invention, indicating which components are compile time elements and which are run time elements; and

FIG. 16 shows an exemplary system block diagram of the computer system that may be utilized to execute the software of an embodiment of the present invention.

The Figures depict embodiments of the present invention for purposes of illustration only. One skilled in the art will readily recognize from the following discussion that alternative embodiments of the structures and methods illustrated herein may be employed without departing from the principles of the invention described herein.

### DESCRIPTION OF THE INVENTION

The present invention is a hybrid of a language interpreter and a Virtual Machine (VM). It is like an interpreter in that some instructions are inspected by the system for validity before they are executed, and it is like a virtual machine in that system code mediates programs' access to certain hardware peripherals. However, it is not fully like either a language interpreter or VM. The system presented hereafter is faster than a language interpreter because applications are pre-compiled and distributed in binary form wherein most instructions are direct translations of the original source code. And the system presented hereafter is more resource-efficient than a VM because it does not require the hosting of a complete operating system to mediate programs' access to memory and hardware. The present invention sandboxes running applications on a microcontroller-level system, operating without memory management hardware support by requiring system firmware intervention for some common operations, such as accessing memory through an arbitrary pointer. While slightly slower than a standard microcontroller-based system wherein firmware runs directly on the processor without any system intervention, the lack of hardware-assisted memory management results in a considerable cost savings and increased flexibility of microprocessor selection.

The present invention includes an implementation of a virtual memory system in which small discrete pages that include both code and data are cached into processor RAM on an as-needed basis from larger external nonvolatile memory. Due to a limited amount of total processor RAM, high performance at run time relies on minimizing the rate of page evictions. This minimization of page evictions at run time is accomplished through an iterative compilation process wherein code is segmented into distinct pages, analysis of the pages determines the likelihood of program flow exiting each page, and these likelihoods then inform re-apportionment of code into pages to result in a minimized likelihood of page evictions. This process can be run multiple times until some desired level of optimization has been reached.

Embodiments of the present invention are hereafter described in detail with reference to the accompanying Figures. Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention.

The following description with reference to the accompanying drawings is provided to assist in a comprehensive understanding of exemplary embodiments of the present invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

By the term substantially it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

A machine instruction is an instruction that directs a computer to perform an operation specified by an operation code and optionally or more operand. A machine instruction is considered to be broader than just machine code.

A virtual machine instruction is a machine instruction for a software emulated microprocessor or computer architecture (also called virtual code).

Native code or a native machine instruction (also referred to as machine code) is a machine instruction that is designed for a specific microprocessor or computer architecture.

A function is a software routine (also referred to as a subroutine, procedure, member function or method.

A program counter is a pointer that points to a machine instruction of the interpreter that is being executed.

Compiling refers to the processing of source code files (.c, or .cpp) and the creation of an ‘object’ file. This step does not create anything the machine can actually run. Instead, the compiler merely produces the machine language instructions, machine code, that correspond to the source code file that was compiled. For instance, if you compile (but do not link) three separate files, you will have three object files created as output, each with the name <filename>.o or <filename>.obj (the extension will depend on your compiler). Each of these files contains a translation of your source code file into a machine language file but each not non-executable. To turn them into executables files they must be linked into executable code.

Linking refers to the creation of a single executable file from multiple object files.

During compilation, if the compiler could not find the definition for a particular function, it would just assume that the function was defined in another file. The linker, on the other hand, will look at multiple files and try to find references for the functions that are not organically defined. The result is a linking of several files into a single executable file that can be run on a machine.

Like numbers refer to like elements throughout. In the figures, the sizes of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. Thus, for example, reference to “a component surface” includes reference to one or more of such surfaces.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be also understood that when an element is referred to as being “on,” “attached” to, “connected” to, “coupled” with, “contacting”, “mounted” etc., another element, it can be directly on, attached to, connected to, coupled with or contacting the other element or intervening elements may also be present. In contrast, when an element is referred to as being, for example, “directly on,” “directly attached” to, “directly connected” to, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

Spatially relative terms, such as “under,” “below,” “lower,” “over,” “upper” and the like, may be used herein for ease of description to describe one element or feature's relationship to another element(s) or feature(s) as illustrated in the figures. It will be understood that the spatially relative terms are intended to encompass different orientations of a device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of “over” and “under”. The device may be otherwise oriented (rotated 90 degrees or at other orientations) and the spatially relative descriptors used herein interpreted accordingly. Similarly, the terms “upwardly,” “downwardly,” “vertical,” “horizontal” and the like are used herein for the purpose of explanation only unless specifically indicated otherwise.

Included in the description are flowcharts depicting examples of the methodology which may be used to create one or more executable programs and one or more partially-virtual execution environments for the one or more executable programs in a resource-constrained computer system. In the following description, it will be understood that each block of the flowchart illustrations, and combinations of blocks in the flowchart illustrations, can be implemented by computer program instructions. These computer program instructions may be loaded onto a computer or other programmable apparatus to produce a machine such that the instructions that execute on the computer or other programmable apparatus create means for implementing the functions specified in the flowchart block or blocks. These computer program instructions may also be stored in a computer-readable memory that can direct a computer or other programmable apparatus to function in a particular manner such that the instructions stored in the computer-readable memory produce an article of manufacture including instruction means that implement the function specified in the flowchart block or blocks. The computer program instructions may also be loaded onto a computer or other programmable apparatus to cause a series of operational steps to be performed in the computer or on the other programmable apparatus to produce a computer implemented process such that the instructions that execute on the computer or other programmable apparatus provide steps for implementing the functions specified in the flowchart block or blocks.

Accordingly, blocks of the flowchart illustrations support combinations of means for performing the specified functions and combinations of steps for performing the specified functions. It will also be understood that each block of the flowchart illustrations, and combinations of blocks in the flowchart illustrations, can be implemented by special purpose hardware-based computer systems that perform the specified functions or steps, or combinations of special purpose hardware and computer instructions.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve the manipulation of information elements. Typically, but not necessarily, such elements may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” “words”, or the like. These specific words, however, are merely convenient labels and are to be associated with appropriate information elements.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

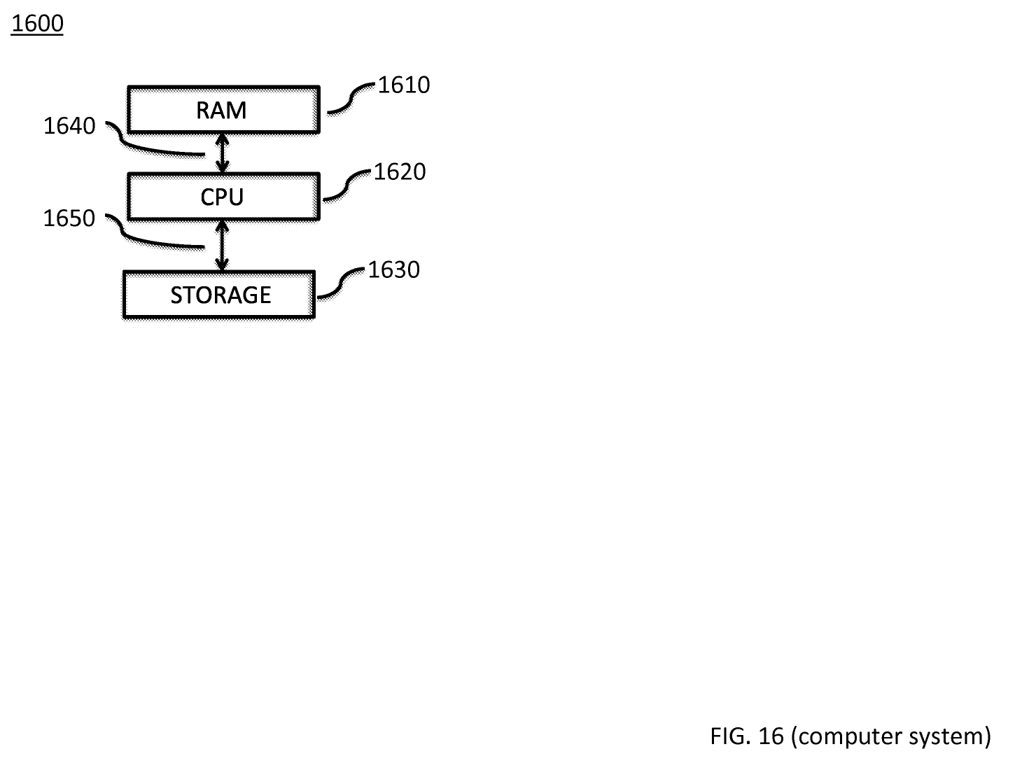

FIG. 16 illustrates a system block diagram of a computer system that may be used to execute the software of an embodiment of the invention. FIG. 16 shows a computer system 1600 which includes RAM 1610, a CPU 1620, and storage (e.g., flash memory) 1630 which may be utilized to store and retrieve software programs incorporating computer code that implements the invention, data for use with the invention, and the like. Additionally, a data signal embodied in a carrier wave (e.g., in a network including the Internet) may be the computer readable storage medium. Other computer systems suitable for use with the invention may include additional or fewer subsystems. For example, another computer system could include more than one processor (i.e., a multiprocessor system), or a cache memory.

The local bus architecture of computer system 1600 is represented by lines 1640 and 1650. However, these lines are illustrative of any interconnection scheme serving to link the subsystems. For example, a system bus could be utilized to connect the central processor 1620 to the system RAM 1610 and storage 1630. Computer system 1600 shown in FIG. 16 is but an example of a computer system suitable for use with the present invention. Other computer architectures having different configurations of subsystems may also be utilized.

In one embodiment of the present invention, a 32-bit ARM microcontroller-based system having the Cortex-M3 core and without hardware-support for memory management, a serial-connected flash memory and a power source is used to execute the software.

According to one embodiment, during the build process, the compiler of the present invention categorizes the program instructions into “safe to directly execute” and “not safe to directly execute” categories. The “safe” instructions are compiled directly to an instruction subset referred to in one embodiment as Thumb-2. One of reasonable skill in the relevant art will appreciate that instruction sets can vary by microcontroller architecture. A Thumb instruction set is a compact 16 bit version of the ARM instruction set. Thumb-2 includes enough operations so as to be able, if necessary, to replace the ARM instruction set. And while most higher-end processors support ARM, Thumb, and Thumb-2, some lower-end processor architecture such as those envisioned for use in the present invention may support only the Thumb-2 instruction set.

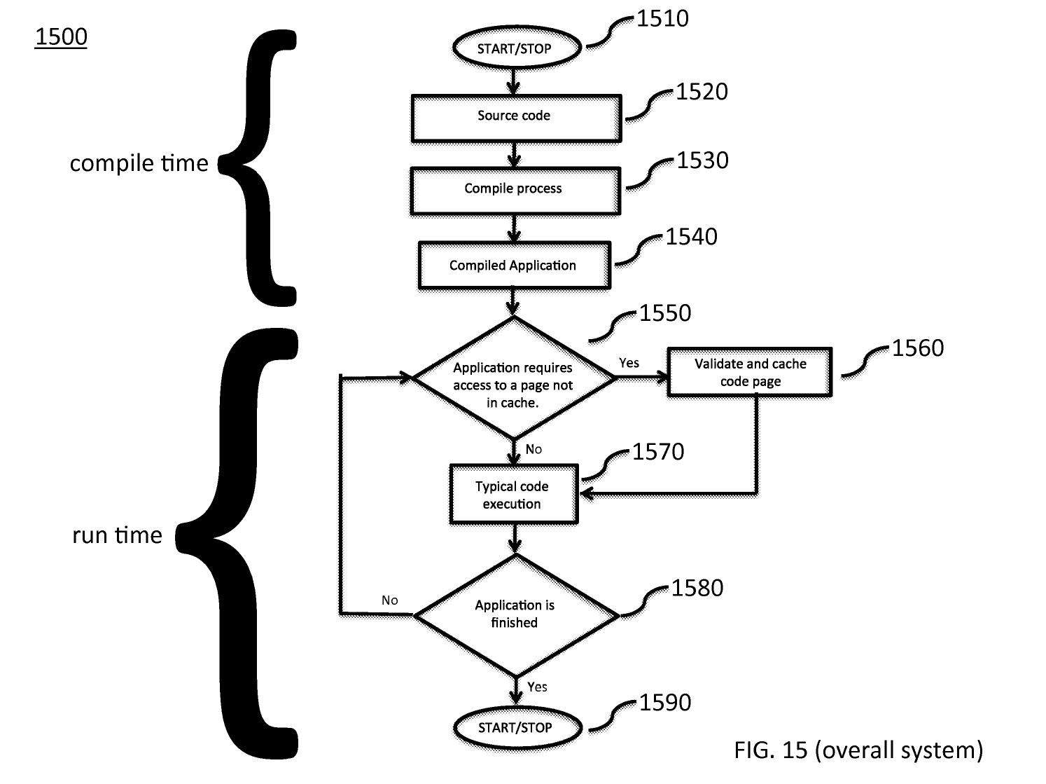

The present invention has a compile-time step and a run time step, as shown in FIG. 15. At compile time 1510, source code 1520 is submitted to a compile process 1530 that turns it into a compiled application 1540. At run time, instructions in the compiled program are executed 1570 for as long as the application is not finished 1580. If the running application requires access to a code page not in the page cache 1550, the system will validate and cache the requested page 1560. When the application is finished running, it stops 1590.

The compile time steps and the run time steps may take place on different computer systems. In practice this is typically the case.

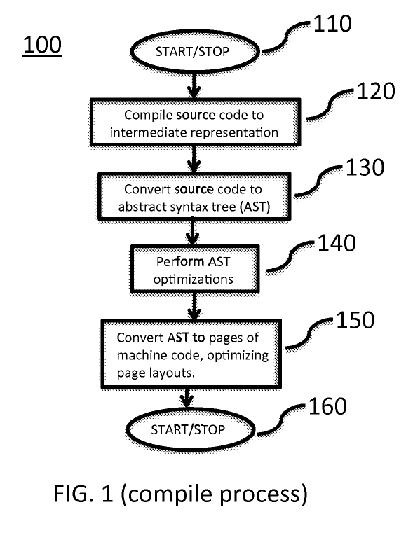

In the compile process 100 of the present invention with reference to FIG. 1, once begun 110 source code is compiled into an intermediate representation 120, then into an abstract syntax tree 130 (AST). The AST representation of the code allows the compiler to make standard compile-time optimizations 140 that are common knowledge to those skilled in the art. Then the AST is converted into discrete pages of machine code that are apportioned so as to optimize their run-time behavior 150, specifically to minimize the expected frequency of program jumps to code outside the page at run time. At this point the compile process is finished 160.

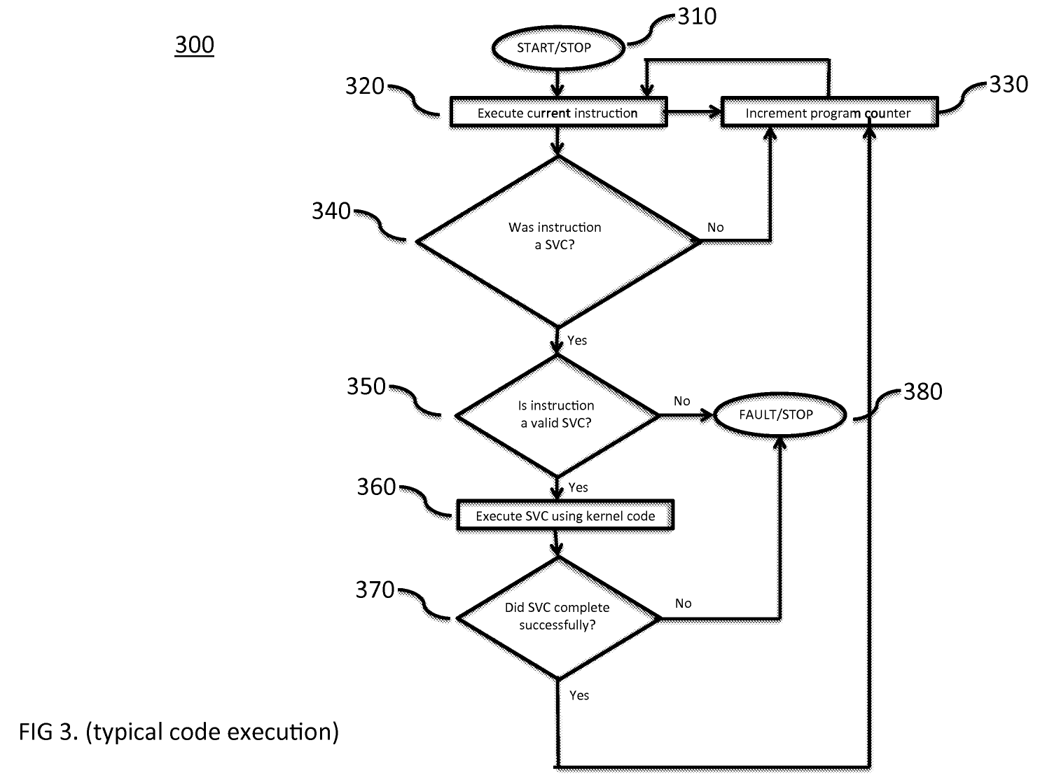

Run time behavior is defined by the typical code execution loop 300 as illustrated in FIG. 3. The most basic behavior is that the CPU executes 310 the current instruction 320, increments the program counter 330, then repeats these two steps for as long as it is running This is standard computer behavior. However, some parts of the code from the original program could not be verified to be safe at compile time, therefore have been replaced with SVC. If the current instruction is a SVC 340, the system then checks to ensure that it was a valid SVC 350. If not, the system will stop with a fault 380. If the SVC was valid, the instructions corresponding to the original code will be executed using kernel code. If something illegal happens during this execution, the system will stop with a fault 380. Otherwise, the CPU increments the program counter 330 and execution moves on to the next instruction 320.

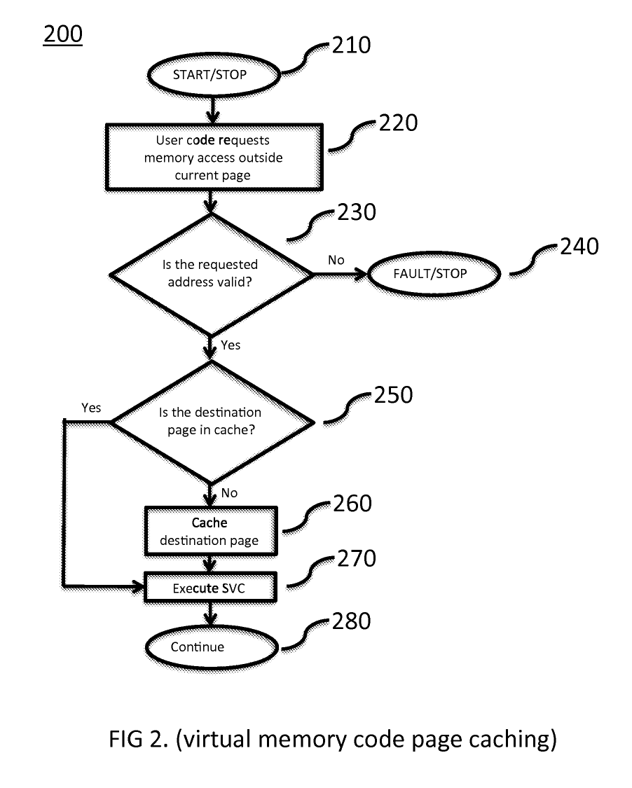

At run time 210 and with reference to FIG. 2, the running application 200 may often need to access a memory location outside the current page 220, either to read or write data, or to jump to a new location. This access is trapped with a SVC, and the system first checks that the requested address is valid 230, stopping with a fault if not 240. If the requested address is valid, the system then checks if the page containing the requested address is already in the cache 250. If not, the system caches the destination page 260. Then whether the page had been already cached or not, the system runs the kernel code associated with the SVC 270 to execute the instruction that required memory access. The SVC returns control to the user space code and the program continues 280.

The trapping of memory accesses with SVCs is an implementation of memory protection in software. In essence the present invention provides virtual memory without hardware support for this feature. To do so the present invention uses a fixed amount of physical memory to cache code pages, loading pages from external storage as needed by the running program as described above. The apportionment of code into pages at compile time allows the compiler to determine which program control jumps will require program access to addresses outside the given page, and therefore must be replaced by supervisor calls. Then as described, these jumps are trapped and the system determines whether the page corresponding to the destination address is already cached or must be loaded from external storage. The process of translating a virtual address to a physical address is not done by dedicated hardware that is typically the case, but rather in the present invention, by software in the form of a supervisor call.

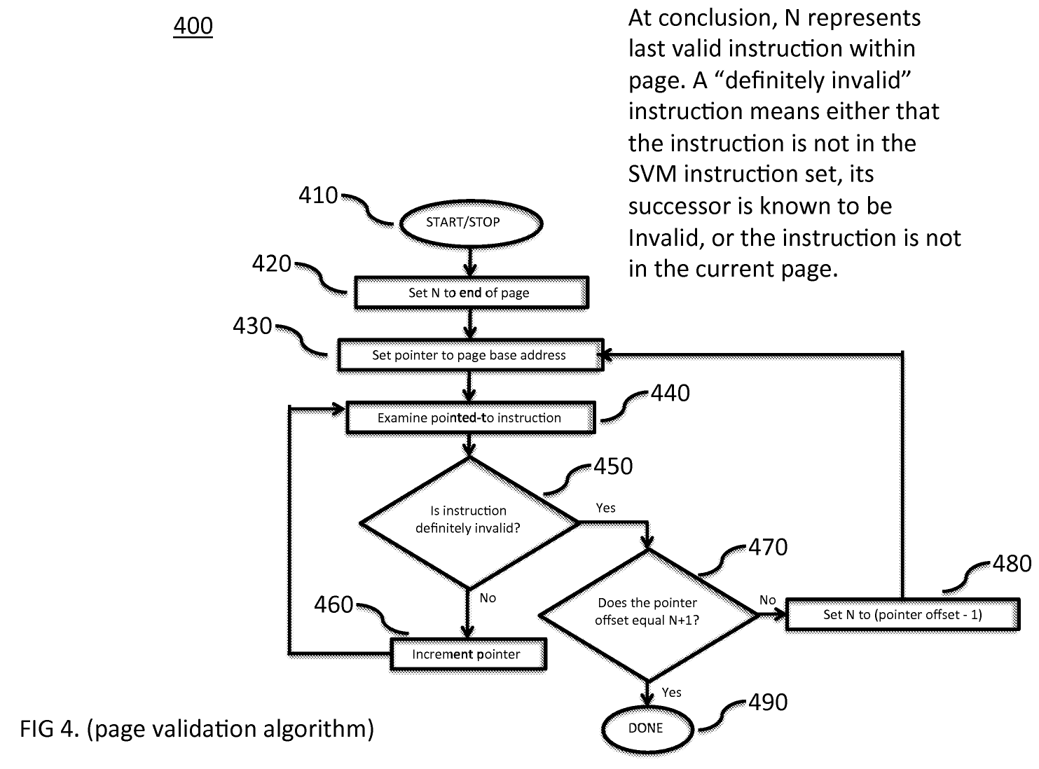

The present invention verifies the validity of each page as it reads it in from flash memory to cache in processor RAM, as shown in FIG. 4. Validity depends on a page having only safe instructions in its code region. Safe instructions avoid unauthorized memory reads or hardware access, and can include operations such as arithmetic, local loops and branches within a block, access to general purpose registers, access to memory relative to the stack pointer, and access to memory relative to a trusted base pointer. The algorithm 400 to verify the validity of a page assumes the structure of pages to be a code region followed by a data region. Its output is the offset into the page at which the boundary between code and data can be found. This results in a verified page because the system will not execute instructions found in the data portion, only from the code portion. It uses a variable to hold its current theory about the offset of the last safe instruction in the past, and begins 410 by setting N to be the last instruction in the page 420. A pointer is set to the base page address 430. A loop commences that involves examining the current instruction pointed to by the pointer 440. If the instruction is not definitively “unsafe” or invalid 450, the pointer is incremented 460 and the algorithm proceeds 440. If the instruction is definitively “unsafe” or invalid, and the pointer offset into the block is still less than or equal to N 470, then the algorithm sets N to equal the value just before the value of the pointer offset 480. In other words, since the algorithm has found an invalid instruction, it and all instructions past it in the block are also invalid - therefore, the furthest possible valid instruction is the one just before the newly discovered invalid one. When the first invalid instruction to be found is at an offset one greater than the current N, the algorithm terminates 490, since this means either that the pointed-to instruction one address past the end of the block and therefore not valid, or the value of N has not changed in the current iteration across the block and therefore has converged. For the purposes of this algorithm, an invalid or “unsafe” instruction is either an instruction that is not in the list of known-safe instructions or it is an instruction whose successor (the next instruction that will be executed after it) is not in the current 0-N range of the current page. A “maybe” instruction (one that is not definitively “unsafe” or invalid) is one whose validity depends on the validity of its successor. After it converges, this algorithm returns the size of the code section of the page.

At run time, the code portion of each page should contain only safe instructions and supervisor calls (traps) (SVC). A trap or interrupt, for the purpose of this invention, is an instruction inserted by the compiler asking the operating system to perform an “unsafe” operation that cannot be known to be safe at compile-time but can be validated by inspection at run time. Operations that may be considered unsafe include system calls (used to implement application-specific operating system functionalities), writing to a trusted base pointer register, allocating/feeing stack space, jumping to or accessing a memory address contained in a different code page and function calls and returns. Thus the “interpreter” of the present invention prevents malicious or buggy code (unsafe instructions) to harm the system. In computing and operating systems, a trap, also known as an exception or a fault, is typically a type of synchronous interrupt typically caused by an exceptional condition (e.g., breakpoint, division by zero, invalid memory access). A trap usually results in a switch to kernel mode, wherein the operating system performs some action before returning control to the originating process. For example, when a processor in a typical system receives a trap or an interrupt, it suspends its current operation, saves the status of its work, and transfers control to a special routine known as an interrupt handler that contains the instructions for dealing with the particular situation that caused the interrupt. Interrupts can be generated by various hardware devices to request service or report problems, or by the processor itself in response to program errors or requests for operating-system services. Interrupts or traps are the processor's way of communicating with the other elements that make up a computer system. The interrupt instructions themselves are trusted native or “kernel” code. According to one embodiment of the present invention, traps are used in place of an operation that would otherwise be deemed unsafe. The present invention uses the compiler to insert Supervisor Calls (interrupts) in place of unsafe operations at compile-time 100 prior to load-time as illustrated in FIG. 1. By doing so the SVC code only needs to be verified and not converted making the code page caching process more efficient.

The general purpose registers in the processor are segmented, according to the present invention, into trusted and untrusted general purpose registers so as to cache validated pointers in order to avoid incurring the computational and execution cost of re-validating these pointers each time they are accessed by the running program.

Therefore, according to one embodiment of the present invention, the general register file is divided into a trusted portion and an untrusted portion). For example, consider a 16 bit general register filed. Memory locations r0-r7 may, in one embodiment of the present invention, be considered “trusted” while register memory locations r8-r15 are not. Trusted registers cannot be directly modified by instructions present in the running program, this modification can only happen in supervisor calls, whereas untrusted registers can be modified arbitrarily by instructions present in the running program. The untrusted registers are available for general purpose use by the “user code” instructions present in the running program. In order to run these “user code” instructions must first be validated. Thus if a code page contains an instruction that attempts to write directly to a trusted register, that instruction will not be considered valid and that page of code will not load.

Note that by comparison in a typical interpreter, it is common to have a “fetch and execute loop” in software, in which the next instruction in the stream is examined so as to decide what kind of instruction it is, and then branch to a software implementation of that instruction. For example if the next instruction is a ‘mov’, then an interpreter of the prior art would examine the arguments to the instruction to determine the source and destination registers, optionally check to validate that the instruction is valid within the rules of the interpreted environment, then make the appropriate software function call to copy the data from the source to the destination. The overhead for this type of operation is quite high. By allowing the CPU to directly execute most instructions and using supervisor calls only for a limited subset of operations, the present invention can effectively let the CPU solve easy problems quickly and the harder problems a little more slowly. By comparison, in a pure interpreter the easy and the hard instructions can be equally slow.

As previously mentioned and shown in FIG. 4, at run time supervisor calls are verified (validated) along with the rest of the code in a page. Validation includes, among other things, a block-load-time analysis that guarantees the block does not transfer flow control outside of the block without going through specific predetermined and established traps. By doing so the cost of memory management is shifted to compile-time, and a quick run time check as a page is cached can verify that the code only contains legal instructions for jumps and other operations involving memory access. Therefore the compiler can optimize virtual memory and the system can verify, as pages from the binary is loaded, that no subsequent tampering has occurred to invalidate the code in each page. As a result, code can be safely secured (sandboxed) with minimal/no hardware support.

For example, registers r8-r9 can be used as trusted base addresses. To simplify the paging mechanism, only one base pointer may be loaded into these trusted registers at any given time and any validation operation may choose to evict pages from the cache. One of reasonable skill in the relevant art will appreciate that this is but one example and other implementations of the present invention are possible and contemplated without departing from the teachings herein.

To maintain separate read and write permissions, the validation operation of the present invention creates separate base pointers in r8 and r9 used for loads and stores, respectively. In this example if an address is valid for read only, r8 will be valid but r9 will be set to an address that produces hardware faults.

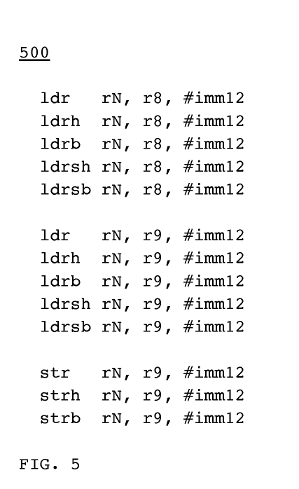

Register r8 is used as a read only base (BRO) and r9 is used as a read/write base address (BRW). The set of valid VM instructions 500 includes a number of operations on r8 and r9 as shown in FIG. 5.

The two base registers may be updated using a supervisor call which copies any r0-r7 to r8-r9 after performing address translation and validation.

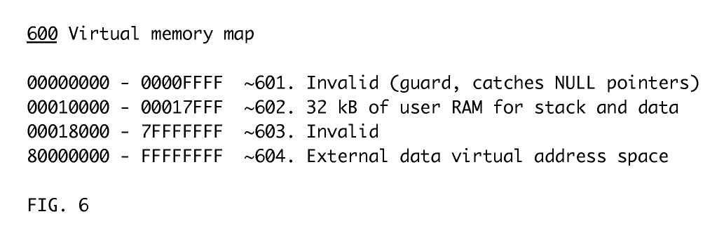

A virtual memory map 600 shown in FIG. 6 defines how virtual addresses are translated into physical memory addresses and devices. Addresses 00000000-0000FFFF are invalid and act as a guard region that can catch NULL pointers. Addresses 00010000-00017FFF are 32 kB of user RAM for stack and data. Addresses 00018000-7FFFFFFF are invalid. Addresses 80000000-FFFFFFFF are external data virtual address space.

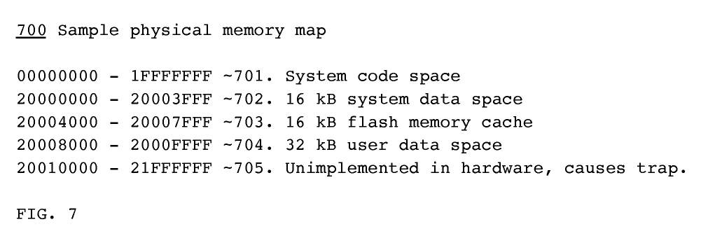

The physical memory of one embodiment of the system of the present invention 700 is apportioned and may be used for system code 701, data 702, flash memory 703, and user data 704 as illustrated in FIG. 7. In one embodiment of the system of the present invention memory addresses 20010000-21FFFFFF are unimplemented in hardware 705, and code that attempts to access them causes a trap.

Turning back to FIG. 6, region 601 is guaranteed to fault on read or write and a NULL pointer plus any imm12 will land in this region. Any invalid pointers will fault on load/store, not on validate, so that the fault occurs only at actual time of use.

Address translation for 601, 602 and 603 can be performed using:
physical=((virtual−0x10000) & 0xFFFFF)+0x20008000

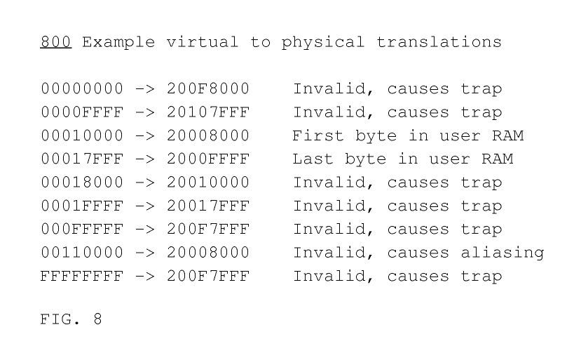

Region 603 is not guaranteed to fault. Some invalid user pointers will silently alias to other valid user RAM addresses, as shown in FIG. 7. FIG. 8 gives examples 800 of some virtual to physical address translations in one embodiment of the system of the present invention.

The behavior within the supervisor calls is responsible for detecting addresses in region 604 and routing them through the system's flash cache. User space code may ‘check out’ a flash page in this manner. The pointer saved to r8-r9 will point to a temporary copy of the flash page, in the cache region 703. The page is only guaranteed to stay at that address until the next supervisor call. This means that function calls, long jumps, and other validate supervisor calls will invalidate the contents of r8-r9.

By placing the cache region 703 immediately prior to user data region 704, the present invention makes out-of-range imm12 values harmless. The worst that a malicious or buggy application can do is to read user data or other cache pages, both of which it could already access. For the same reason, this also means the present invention can allow literal pool loads without checking the immediate.

The flash memory cache 703 is treated as a read-only region in this scheme. Actual writes to flash, e.g. for saved game data, are performed using special-purpose system calls. This simplifies the design, as well as adding a layer of protection against inadvertent writes.

Thus the architecture of the virtual memory system permits applications to run efficiently and safely, preventing malicious or buggy code from performing illegal operations while simultaneously minimizing the likelihood of problems surfacing should this happen.

Another aspect of the present invention is the instruction set architecture. The SVM architecture uses, in this example, a reduced subset of “Thumb-2” instructions, which contains only operations that are always safe for unprivileged code to perform. The architecture is designed such that any page of code can be quickly validated at load time to determine which portion of the page contains valid instructions. Any page can be divided into a data portion at the end, and a code portion at the beginning By walking the page from beginning to end at load time the highest address that represents valid code is determined to be the end of the code portion.

In order to support the use of 32-bit Thumb-2 instructions without overcomplicating the validation algorithm, the present invention requires all basic blocks and all 32-bit instructions to be aligned on a 32-bit boundary. This means that validation can proceed 32 bits at a time, checking whether each word contains either a single valid 32-bit instruction or two valid 16-bit instructions. No type of branch is allowed to enter an address that is not 32-bit aligned.

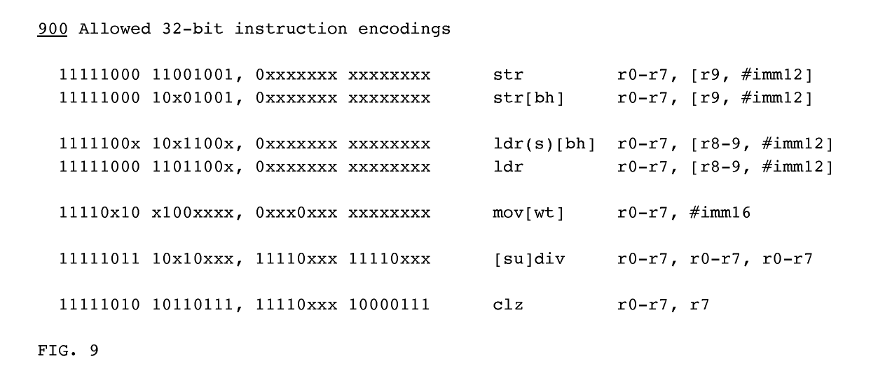

According to one embodiment of the present invention, allowed 32-bit instruction 900 encodings may include those listed in FIG. 9.

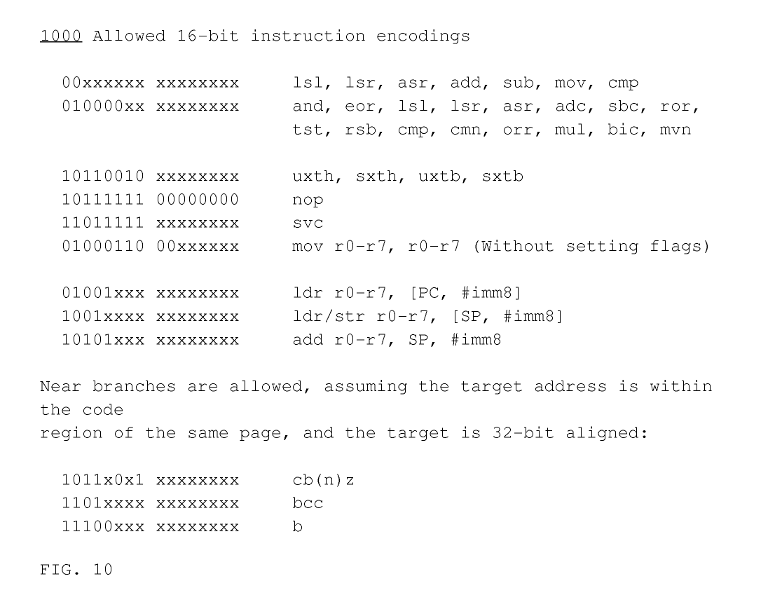

According to one embodiment of the present invention, allowed 16-bit instruction 1000 encodings may include those listed in FIG. 10.

In one version of the present invention common operations require hypercall assistance. These can include stack frame adjustments, long branches, procedure call and return, pointer validation, and application-visible system calls.

All hypercalls are implemented using supervisor calls. In other versions of the present invention BKPT could be used or the permanently undefined regions as well, should the system require more than 8 bits of parameter space.

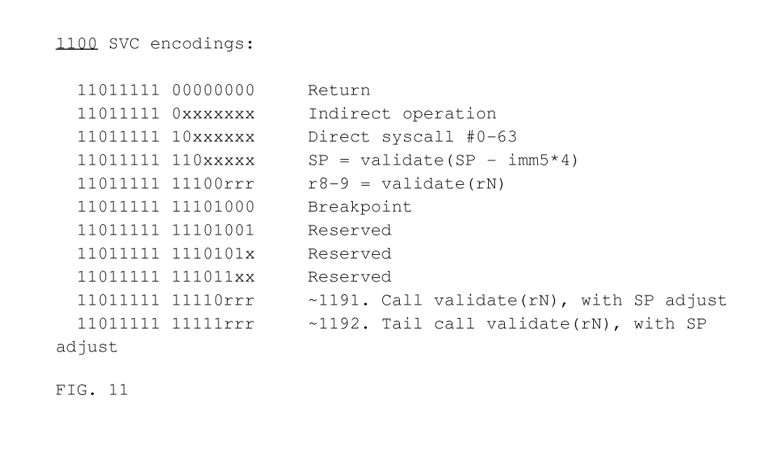

Encodings 1100 for one embodiment of the present invention are listed in FIG. 11.

During indirect calls 1191 and 1192, the least significant 2 bits and most significant 1 bit are ignored. It is recommended that at least one of these bits is nonzero, to differentiate a legitimate function at 0x80000000 with an SP adjust of zero from a NULL pointer. Currently the present invention sets the least significant bit for this purpose.

Since 0 is never a valid indirect address (every code page by definition has a valid instruction at the beginning), code 0x00 is reserved for Return. Direct syscalls shall be used for very common operations: memcpy, memset, floating point, return, etc.

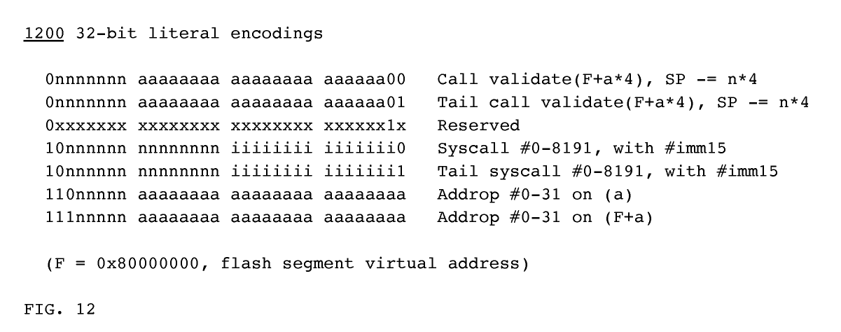

When the most significant bit of the supervisor call immediately is clear, the other 7 bits are multiplied by four and added to the base of the current page, to form the address of a 32-bit literal. This 32-bit literal encodes an indirect operation to perform 1200 as shown in FIG. 12.

Address operations are akin to syscalls, but they have a 24-bit immediate which is large enough to hold any arbitrary flash or RAM address. Defined addrop numbers include 1310, 1320, 1330, 1335, 1340, and 1350:

The present invention, in one embodiment, uses the following call convention:

All arguments and return values are extended or split as necessary, to yield a sequence of 32-bit values.

Parameters are passed in r0-r7.

Return values are in r0-r1. This simple calling convention supports at most 64 bits of return data. (Necessary for returning double-precision floats).

Registers r0-r1 are always clobbered by a call. This allows the syscall dispatch code to treat all syscalls equally, instead of having separate paths depending on how many values are returned.

Registers r2-r7 are automatically saved by a call and restored on a return.

The call/tcall/ret SVCs internally push/pop a stack frame which contains saved registers: Frame, PC, r2-r7.

They also maintain a frame pointer, guaranteed to be pointing to these saved values. Note that SP itself is not stored, since the location of the saved values will also implicitly be the value of the saved SP. Saving the previous frame pointer, though, will link the stack frames together. (The frame pointer is useful so we can return without knowing how large the stack frame was, but it's especially important if the function ever allocates additional stack space for itself using a SVC.)

If not all parameters fit in r0-r7, additional parameters are passed on the stack, by placing them at the bottom of the caller's stack frame. The callee reaches upward into the parent stack frame to read these values. This means that the compiler must be able to calculate the distance between the caller's stack frame and the callee's.

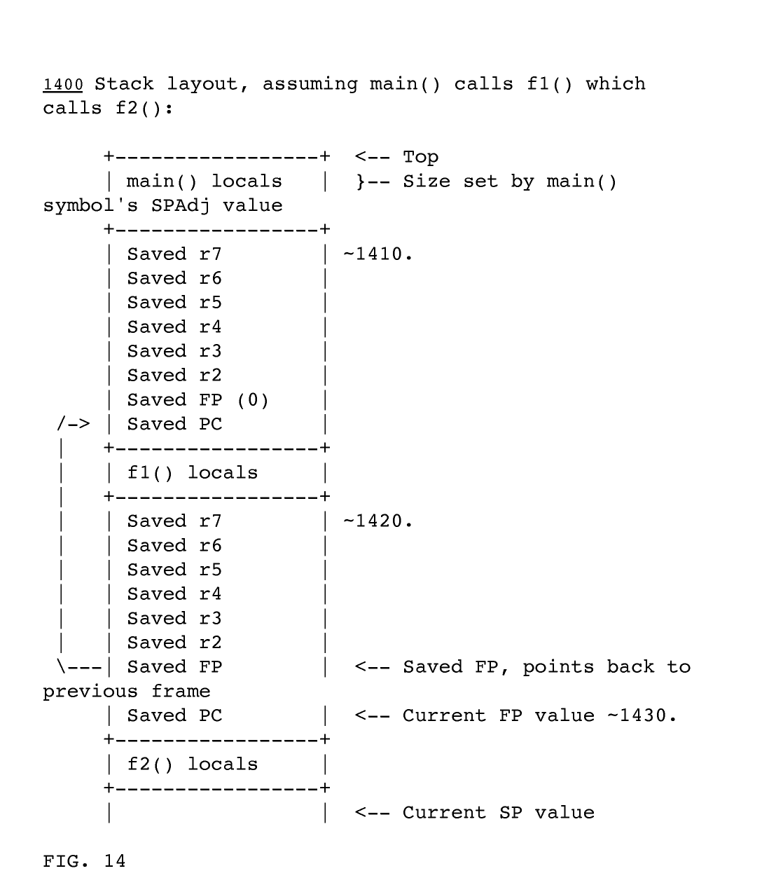

The stack layout 1400 is defined by the ABI and illustrated in FIG. 14 which assumes main( )calls f1( )which calls f2( ). A ‘call’ is required to save exactly 8 words of data 1410, 1420 between the parent stack frame and the child stack frame.

To excute a return:
Assign SP=FP
Restore saved registers 1420
Long branch to saved PC 1430

If FP was 0, this is a special case that can only occur when returning from main( ) This will in fact be our first cue that we are returning from main( ) so it can be taken as an instruction to invoke_SYS_exit( )

The present invention provides an application sandboxing environment that is both quick and secure and which can operate on minimally capable processors. This is accomplished by dividing code into blocks that each run natively on the processor but only after they have been validated as conducting exclusively safe operations. The set of safe operations is defined such that the validation can be performed quickly on the hardware and once validated and cached the instructions remain available to the processor in ram until evicted. Moreover code that is externally stored can be loaded page-wise into RAM for execution. During loading this code is validated to contain only safe operations, and is otherwise terminated with a fault.

As introduced above, the ability to virtualize memory and cache pages as they are required by the running application is one aspect of the present invention. By doing so code can be kept externally and then on demand the code can be moved to an area of internal RAM to be run. Thus binaries much larger than would be capable of being stored in on-chip nonvolatile code memory or on-chip RAM can be executed safely. This is related to the fact that traditional hardware-assisted memory management is replaced in the present invention by a virtual memory management system. In the present invention the compiler apportions the code into memory blocks and designs jumps between the code that are traversed at run time. The complier can identify code that jumps between addresses within a single block and can use instructions that do not invoke a supervisor call to do so. When accessing code address outside the current block the compiler cannot know if the destination address will be within a block that is currently cached at run time, thus behavior within the supervisor call converts the virtual address to a physical address right before the system executes the access. This again is done without hardware support.

The present invention also protects the operating system, without using hardware, from an application's ability to overwrite code or make low-level changes that could irreparably alter the operating system's stability and operability. Moreover, by identifying when code is needed and paging in and caching in RAM the code from external memory, the size of the external code (game) is not limited by either the amount of system RAM or onboard nonvolatile storage. At run time, code is paged into system RAM as-needed and prior to being run the code is validated.

The present invention is an architecture that enables software applications to run efficiently and securely on hardware that was designed to run applications on the “bare metal” without sandboxing. It has applications in many areas of products built around embedded devices where low cost, low power, robust run time behavior, and a system's flexibility to adopt new behavior based on software applications are important. These requirements describe an extremely large range of modern devices.

In one embodiment, the system comprising this invention can be as minimal as CPU, RAM, and a storage medium.

Upon reading this disclosure, those of skill in the art will appreciate still additional alternative structural and functional designs for a system and a process for creating one or more executable programs and one or more partially-virtual execution environments for the one or more executable programs in a resource-constrained computer system through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

It will also be understood by those familiar with the art, that the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

In a preferred embodiment, the present invention can be implemented in software. Software programming code that embodies the present invention is typically accessed by a microprocessor from long-term, persistent storage media of some type, such as a flash drive or hard drive. The software programming code may be embodied on any of a variety of known media for use with a data processing system, such as a diskette, hard drive, CD-ROM, or the like. The code may be distributed on such media, or may be distributed from the memory or storage of one computer system over a network of some type to other computer systems for use by such other systems. Alternatively, the programming code may be embodied in the memory of the device and accessed by a microprocessor using an internal bus. The techniques and methods for embodying software programming code in memory, on physical media, and/or distributing software code via networks are well known and will not be further discussed herein.

Generally, program modules include routines, programs, objects, components, data structures and the like that perform particular tasks or implement particular abstract data types. Moreover, those skilled in the art will appreciate that the invention can be practiced with other computer system configurations, including hand-held devices, multi-processor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

An exemplary system for implementing the compile portion of the invention includes a general purpose computing device such as the form of a conventional personal computer, a personal communication device or the like, including a processing unit, a system memory, and a system bus that couples various system components, including the system memory to the processing unit. As is illustrated below, the runtime portion of the invention implemented by a microcontroller. In a general purpose computing system, the system bus may be any of several types of bus structures including a memory bus or memory controller, a peripheral bus, and a local bus using any of a variety of bus architectures. The system memory generally includes read-only memory (ROM) and random access memory (RAM). A basic input/output system (BIOS), containing the basic routines that help to transfer information between elements within the personal computer, such as during start-up, is stored in ROM. The personal computer may further include various media for data management including a hard disk drive for reading from and writing to a hard disk, a magnetic disk drive for reading from or writing to a removable magnetic disk. The drives and their associated computer-readable media provide non-volatile storage of computer readable instructions, data structures, program modules and other data for the personal computer.

An exemplary system for implementing the runtime portion of the invention includes a microcontroller having a CPU and RAM and some amount of internal persistent storage for code memory that communicates with an external storage device containing application programs. The CPU in this microcontroller example and consistent with the present invention does not have hardware support for memory management, and can run the Thumb-2 subset of the ARM instruction set.

Embodiments of the present invention as have been herein described may be implemented with reference to various wireless networks and their associated communication devices. Networks can also include mainframe computers or servers, such as a gateway computer or application server (which may access a data repository). A gateway computer serves as a point of entry into each network. The gateway may be coupled to another network by means of a communications link. The gateway may also be directly coupled to one or more devices using a communications link. Further, the gateway may be indirectly coupled to one or more devices. The gateway computer may also be coupled to a storage device such as data repository.

An implementation of the present invention may also be executed in a

Web environment, where software installation packages are downloaded using a protocol such as the HyperText Transfer Protocol (HTTP) from a Web server to one or more target computers (devices, objects) that are connected through the Internet. Alternatively, an implementation of the present invention may be executing in other non-Web networking environments (using the Internet, a corporate intranet or extranet, or any other network) where software packages are distributed for installation using techniques such as Remote Method Invocation (“RMI”) or Common Object Request Broker Architecture (“CORBA”). Configurations for the environment include a client/server network, as well as a multi-tier environment. Furthermore, it may happen that the client and server of a particular installation both reside in the same physical device, in which case a network connection is not required. (Thus, a potential target system being interrogated may be the local device on which an implementation of the present invention is implemented.)

Although the invention has been described and illustrated with a certain degree of particularity, it is understood that the present disclosure has been made only by way of example and that numerous changes in the combination and arrangement of parts can be resorted to by those skilled in the art without departing from the spirit and scope of the invention, as hereinafter claimed.

While the invention has been particularly shown and described with reference to embodiments, it will be understood by those skilled in the art that various other changes in the form and details may be made without departing from the spirit and scope of the invention.

Embodiments of the present invention and many of its improvements have been described with a degree of particularity. It should be understood that this description has been made by way of example, and that the invention is defined by the scope of the following claims.

As will be understood by those familiar with the art, the invention may be embodied in other specific forms without departing from the spirit or essential characteristics thereof. Likewise, the particular naming and division of the modules, managers, functions, systems, engines, layers, features, attributes, methodologies, and other aspects are not mandatory or significant, and the mechanisms that implement the invention or its features may have different names, divisions, and/or formats. Furthermore, as will be apparent to one of ordinary skill in the relevant art, the modules, managers, functions, systems, engines, layers, features, attributes, methodologies, and other aspects of the invention can be implemented as software, hardware, firmware, or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment. Accordingly, the disclosure of the present invention is intended to be illustrative, but not limiting, of the scope of the invention, which is set forth in the following claims.

While there have been described above the principles of the present invention in conjunction with a hybrid virtual machine architecture, it is to be clearly understood that the foregoing description is made only by way of example and not as a limitation to the scope of the invention. Particularly, it is recognized that the teachings of the foregoing disclosure will suggest other modifications to those persons skilled in the relevant art. Such modifications may involve other features that are already known per se and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The Applicant hereby reserves the right to formulate new claims to such features and/or combinations of such features during the prosecution of the present application or of any further application derived therefrom.

1. A method for creating one or more executable programs and one or more partially-virtual execution environments for the one or more executable programs in a resource-constrained computer system, the method comprising:
segmenting program instructions into two categories;
identifying program instructions in the first category of program instructions as suitable for direct translation into machine instructions;
associating each program instruction in the second category of program instructions with a supervisor call wherein at run time the supervisor call executes one or more native instructions to verify whether the original program instruction is safe to execute; and
responsive to the original program instruction being verified at run time as safe to execute, executing the original program instruction associated with the supervisor call; and
apportioning a program into one or more pages of code wherein each page of code includes a code region and a data region.

2. The method for creating programs and a partially-virtual execution environment for these programs in a resource-constrained computer system of claim 1, wherein the first category of program instructions are deemed safe for direct execution at run time.

3. The method for creating programs and a partially-virtual execution environment for these programs in a resource-constrained computer system of claim 2, wherein the first category of program instructions is selected from a group consisting of arithmetic operations, local loop and branch operations within a code block, operations accessing general purpose registers, operations accessing memory relative to a stack pointer, and operations accessing memory relative to a trusted base pointer.

4. The method for creating programs and a partially-virtual execution environment for these programs in a resource-constrained computer system of claim 1, wherein the second category of program of instructions is designated as not safe to directly execute at run time.

5. The method for creating programs and a partially-virtual execution environment for these programs in a resource-constrained computer system of claim 4, wherein the second category of program instructions is selected from a group consisting of operations writing to a trusted base pointer register, operations for allocating or freeing stack space, operations for accessing an address contained in a different code block, function calls and return operations.

6. The method for creating programs and a partially-virtual execution environment for these programs in a resource-constrained computer system of claim 1, wherein the supervisor calls implement a trap that directs the execution environment into validation instructions that may validate or invalidate the original program instructions.

7. The method for creating programs and a partially-virtual execution environment for these programs in a resource-constrained computer system of claim 1, further comprising apportioning the program into pages of code that minimize the expected frequency of program jumps at run time to memory addresses outside the page.

8. The method for creating programs and a partially-virtual execution environment for these programs in a resource-constrained computer system of claim 1, further comprising replacing memory management hardware with software in the form of supervisor calls to validate memory accesses that cannot be determined to be safe at compile-time.

9. The method for creating programs and a partially-virtual execution environment for these programs in a resource-constrained computer system of claim 1, further comprising verifying the validity of all instructions in the code region of each page at run time.

10. The method for creating programs and a partially-virtual execution environment for these programs in a resource-constrained computer system of claim 1, wherein no type of branch is allowed to enter an address which is not 32-bit aligned.

11. A hybrid system for sandboxing applications, comprising:
a compiler operable to convert a program into a plurality of pages of code wherein each page of code includes a first category of program instructions and a second category of program instructions wherein the first category of program instructions are identified as suitable for direct translation into machine instructions and the second category of program instructions are replaced by associated supervisor calls; and
an interrupt module operable at run time to pass program control upon execution of said supervisor calls to trusted system code that validates the safety of the associated program instructions and wherein responsive to validation of the safety of the associated program instructions enables execution of the associated program instructions.

12. The hybrid system for sandboxing applications according to claim 11, wherein the first category of program of instructions is designated as safe to directly execute at run time.

13. The hybrid system for sandboxing applications according to claim 12, wherein the first category of program instructions is selected from a group consisting of arithmetic operations, local loop and branch operations within a code block, operations accessing general purpose registers, operations accessing memory relative to a stack pointer, and operations accessing memory relative to a trusted base pointer.

14. The hybrid system for sandboxing applications according to claim 11, wherein the second category of program of instructions is designated as not safe to directly execute at run time.

15. The hybrid system for sandboxing applications according to claim 14, wherein the second portion of program instructions can be modified arbitrarily.

16. The hybrid system for sandboxing applications according to claim 14, wherein the second category of program instructions is selected from a group consisting of operations writing to a trusted base pointer register, operations for allocating or freeing stack space, operations for accessing a different code block and function calls and return operations.

17. The hybrid system for sandboxing applications according to claim 11, wherein converting includes verifying that flow control remains within a specified page of code unless directed by an inserted supervisor call.

18. The hybrid system for sandboxing third party applications according to claim 11 wherein the compiler apportions the program into pages of code to minimize the expected frequency of program jumps to code outside the page at run time.

19. The hybrid system for sandboxing third party applications according to claim 11, wherein the functionality of memory management hardware is replaced by software in the form of supervisor calls to validate memory accesses that cannot be determined to be safe at compile-time.

20. The hybrid system for sandboxing third party applications according to claim 11 wherein the validity of all instructions in the code region of each page is verified at run time.

21. The hybrid system for sandboxing third party applications according to claim 11 wherein no type of branch is allowed to enter an address which is not 32-bit aligned.
